(19) United States
(12) Patent Application Publication
(10) Pub. No.: US 2007/0159052 A1
(43) Pub. Date: Jul. 12, 2007

(54) Flat fluorescent lamp and method of manufacturing the same

(75) Inventors: Jin-Seob Byun, Seoul (KR); Don-Chan Cho, Gyeonggi-do (KR); Hae-Il Park, Seoul (KR); Sang-Yu Lee, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/584,083

(22) Filed: Oct. 20, 2006

(30) Foreign Application Priority Data
Jan. 11, 2006 (KR) 2006-3268

(51) Int. Cl. H01J 1/62; H01J 63/04

(52) U.S. Cl. 313/489; 313/634; 313/484; 313/635

(57) ABSTRACT

Various structures are disclosed to provide flat fluorescent lamps adapted to provide improved optical characteristics by reducing sodium elution from one or more glass plates. Related methods of manufacture are also provided. In one example, a flat fluorescent lamp includes a first plate and a second plate adapted to form a plurality of discharge chambers in combination with the first plate. A first elution preventive layer is provided on an inner surface of the second plate. A first fluorescent layer is provided above an inner surface of the first plate. A second fluorescent layer is provided above the first elution preventive layer. In another example, the first and second plates comprise sodalime glass. In another example, the elution preventive layer is adapted to prevent sodium eluted from the second plate from exceeding a predetermined sodium elution amount.

### RELATED APPLICATIONS

This application claims priority to Korean Patent Application No. 2006-0003268, filed in the Korean Intellectual Property Office, Republic of Korea, on Jan. 11, 2006, the disclosure of which is incorporated herein by reference in its entirety.

### BACKGROUND

1. Field of the Invention

The present invention relates generally to flat fluorescent lamps and methods of manufacturing the same. More particularly, the present invention relates to improving the lifetime of flat fluorescent lamps and their associated light emissive characteristics by reducing sodium (Na) elution from glass plates.

2. Description of Related Art

Liquid crystal displays (LCDs) are one of the more widely used types of flat panel display devices. An LCD includes two transparent substrates provided with field-generating electrodes (i.e., a pixel electrode and a common electrode) and a liquid crystal (LC) layer interposed therebetween. The LCD displays images by applying voltages to the field-generating electrodes to generate an electric field in the LC layer, which controls the orientation of the LC molecules in the LC layer to affect the polarization of light passing therethrough.

Light for the LCD is supplied by an internal source, such as a lamp contained in the LCD. For large LCD displays, flat fluorescent lamps have been developed which are disposed opposite to, and emit light toward, the display area of LCDs. Such flat fluorescent lamps can include an upper glass plate, a lower glass plate, and a plurality of discharge chambers. The upper plate can be processed to form the discharge chambers which are provided by coupling the upper plate with the lower plate. The upper and the lower plates can be formed of sodalime glass due to its manufacturing convenience and low cost.

Sodalime glass includes sodium (Na) which exhibits high mobility. The sodium is eluted from the glass plates into the discharge chambers during high temperature manufacturing processes and in response to electric fields applied to the lamp during use. The eluted sodium reacts with mercury (Hg) in the discharge chambers to form amalgam, thereby reducing the amount of mercury in the discharge chambers and reducing light transmittance. As a result, the lifetime and light emissive characteristics of the flat fluorescent lamps are degraded.

Therefore, there is a need for an improved flat fluorescent lamp that reduces sodium elution. In addition, there is a need for an improved method of manufacturing the same.

### BRIEF SUMMARY

In accordance with embodiments of the present invention further described herein, flat fluorescent lamps can be provided with improved optical characteristics by reducing sodium elution from one or more glass plates. Methods of manufacturing the lamps are also provided.

In one embodiment, a flat fluorescent lamp includes a first plate, a second plate adapted to form a plurality of discharge chambers in combination with the first plate, a first elution preventive layer on an inner surface of the second plate, a first fluorescent layer above an inner surface of the first plate, and a second fluorescent layer above the first elution preventive layer.

In another embodiment, the first elution preventive layer comprises at least one selected from the group consisting of silicon oxide, silicon nitride, and aluminum oxide. In another embodiment, the first and second plates comprise sodalime glass.

In another embodiment, the second plate comprises chamber portions separated apart from the first plate to form the discharge chambers, partition portions adapted to separate the discharge chambers, and sealing portions at edges of the second plate.

In another embodiment, a reflective layer is provided between the first plate and the first fluorescent layer. In another embodiment, a second elution preventive layer is provided between the first plate and the reflective layer. In another embodiment, a first protective layer is provided between the reflective layer and the first fluorescent layer, and a second protective layer is provided between the first elution preventive layer and the second fluorescent layer.

In another embodiment, a flat fluorescent lamp includes a first plate, a second plate adapted to form a plurality of discharge chambers in combination with the first plate, and a first elution preventive layer on an inner surface of the second plate and adapted to prevent sodium eluted from the second plate from exceeding a predetermined sodium elution amount.

In another embodiment, the sodium elution amount is in a range of about 0% wt to about 10 wt %. In another embodiment, the first elution preventive layer comprises at least one selected from the group consisting of: silicon oxide, silicon nitride, and aluminum oxide. In another embodiment, the flat fluorescent lamp further includes a first fluorescent layer above an inner surface of the first plate, and a second fluorescent layer above the first elution preventive layer.

In another embodiment, a liquid crystal display (LCD) device includes a LCD panel adapted to display images, a driving circuit adapted to provide a plurality of data signals and gate signals to the LCD panel, a flat fluorescent lamp configured to provide light to the LCD panel, and an inverter adapted to provide a discharge voltage to the flat fluorescent lamp. In such an embodiment, the flat fluorescent lamp includes a first plate, a second plate adapted to form a plurality of discharge chambers in combination with the first plate, a first elution preventive layer on an inner surface of the second plate and adapted to prevent sodium eluted from the second plate from exceeding a predetermined sodium elution amount, a first fluorescent layer above an inner surface of the first plate, and a second fluorescent layer above the first elution preventive layer.

In another embodiment, a method for manufacturing a flat fluorescent lamp includes forming a first fluorescent layer above an inner surface of a first plate, molding a second plate to have a desired shape, forming a first elution preventive layer on an inner surface of the second plate, forming a second fluorescent layer above the first elution preventive layer, and combining the first and second plates to form a plurality of discharge chambers, wherein the inner surfaces of the first and second plates face each other.

In another embodiment, the first elution preventive layer comprises at least one selected from the group consisting of: silicon oxide, silicon nitride, and aluminum oxide. In another embodiment, the first and second plates comprise sodalime glass. In another embodiment, the first elution preventive layer is formed by a chemical vapor deposition (CVD) process.

In another embodiment, the method further includes forming a reflective layer between the first plate and the first fluorescent layer. In another embodiment, the method further includes forming a second elution preventive layer between the first plate and the reflective layer. In another embodiment, the method further includes forming a first protective layer between the reflective layer and the first fluorescent layer, and forming a second protective layer between the first elution preventive layer and the second fluorescent layer. In another embodiment, the method further includes preventing sodium eluted from the second plate from exceeding a predetermined sodium elution amount.

A better understanding of the above and many other features and advantages of the present invention may be obtained from a consideration of the detailed description of the exemplary embodiments thereof below, particularly if such consideration is made in conjunction with the several views of the appended drawings, wherein like reference numerals are used to identify like elements illustrated in one or more of the figures thereof.

### BRIEF DESCRIPTION OF THE DRAWINGS

FIG. 1 is a perspective view of a flat fluorescent lamp in accordance with an embodiment of the present invention;

FIG. 2 is a cross-sectional view taken along the line I-I′ of the flat fluorescent lamp of FIG. 1 in accordance with an embodiment of the present invention;

FIG. 3 is a cross-sectional view taken along the line II-II′ of the flat fluorescent lamp of FIG. 1 in accordance with an embodiment of the present invention;

FIG. 4 is a cross-sectional view of another flat fluorescent lamp in accordance with an embodiment of the present invention;

FIGS. 5 and 6 are cross-sectional views showing process steps for forming a flat fluorescent lamp in accordance with an embodiment of the present invention; and,

FIG. 7 is an exploded perspective view of a LCD in accordance with an embodiment of the present invention.

### DETAILED DESCRIPTION

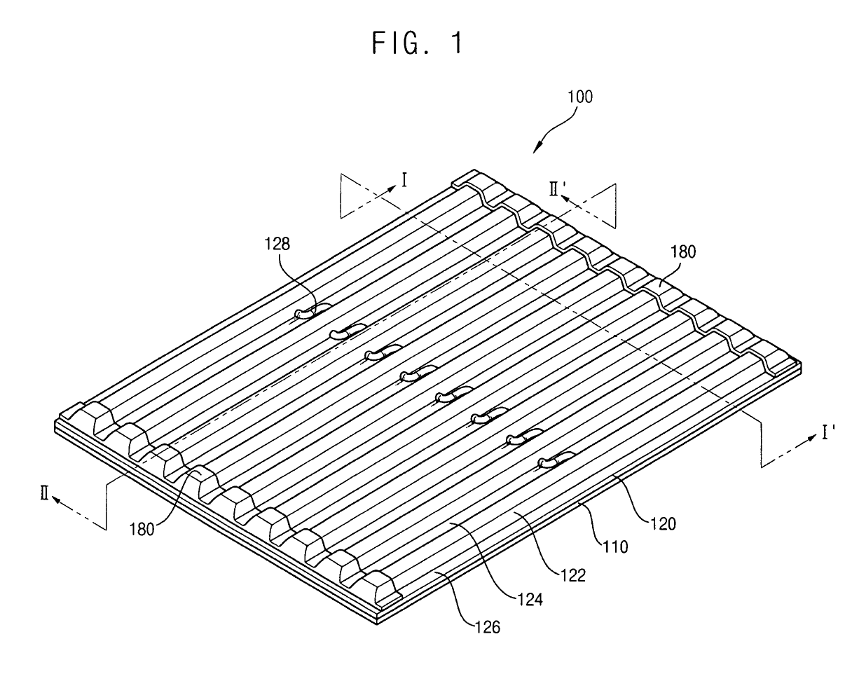

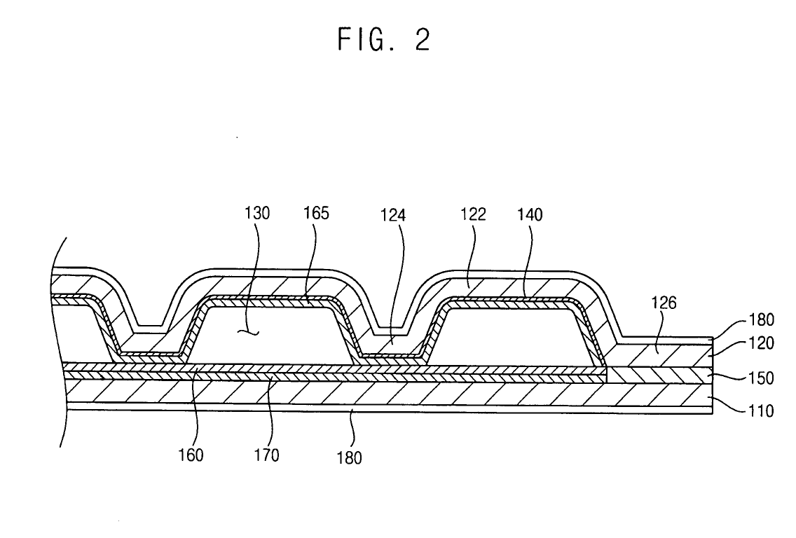

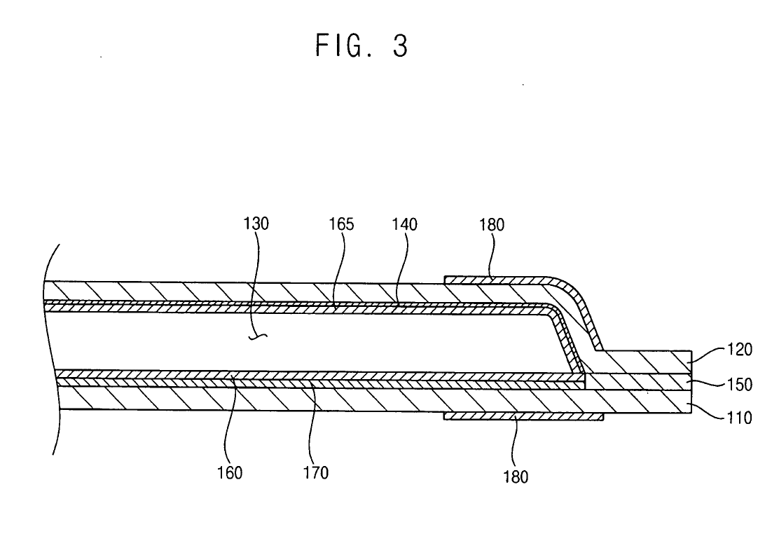

FIG. 1 is a perspective view of an embodiment of a flat fluorescent lamp 100 in accordance with an embodiment of the present invention. FIG. 2 is a cross-sectional view taken along the line I-I′ of the flat fluorescent lamp 100 of FIG. 1 in accordance with an embodiment of the present invention. FIG. 3 is a cross-sectional view taken along the line II-II′ of the flat fluorescent lamp 100 of FIG. 1 in accordance with an embodiment of the present invention.

Referring to FIGS. 1 to 3, flat fluorescent lamp 100 includes a first plate 110 and a second plate 120. Second plate 120 is coupled with first plate 110 to provide a plurality of discharge chambers 130. Discharge chambers 130 emit light, are separated apart from one another, and exhibit a substantially rectangular shape.

In response to electric power provided from an external inverter (not shown in FIGS. 1 to 3), flat fluorescent lamp 100 generates plasma discharge in discharge chambers 130. The plasma discharge emits ultraviolet rays which are converted to visible rays emitted from flat fluorescent lamp 100. Flat fluorescent lamp 100 has a relatively large light-emitting area which increases its light-emitting efficiency. The internal structure of flat fluorescent lamp 100 is divided into discharge chambers 130 to provide substantially uniform luminance.

First plate 110 has a substantially rectangular shape and is formed of sodalime glass. Second plate 120 is also formed of sodalime glass. First plate 100 and second plate 200 can further include ultraviolet blocking layers to prevent ultraviolet light from leaking through the first and second plates 110 and 120.

In one embodiment, second plate 120 is processed to have a desired shape by heating sodalime glass to a temperature equal to or greater than its softening point (i.e., to a temperature at which the sodalime glass becomes flexible enough to change shape). In one embodiment, second plate 120 has a softening point of about 727° C. The sodalime glass is then molded using blow molding techniques employing compressed air. In another embodiment, second plate 120 is processed to have a desired shape by heating the sodalime glass to a determined temperature and then molding the sodalime glass using a cast.

The softening point of sodalime glass depends on its impurity contents. For example, the softening point can decrease as the impurity contents of the sodalime glass increases. Examples of such impurities include sodium (Na), potassium (K), calcium (Ca), and magnesium (Mg).

Because of its high mobility, sodium can be eluted into discharge chambers 130 by high temperature manufacturing processes and electric fields applied to flat fluorescent lamp 100. The eluted sodium reacts with mercury (Hg) in discharge chambers 130 to form amalgam, thereby reducing mercury and light transmittance to degrade the lifetime and emissive characteristics of flat fluorescent lamp 100.

Flat fluorescent lamp 100 includes a first elution preventive layer 140 to reduce sodium elution from second plate 120. First elution preventive layer 140 is formed on an inner surface of second plate 120 facing first plate 110. First elution preventive layer 140 can be formed of silicon oxide (SiO₂), silicon nitride (SiNₓ), aluminum oxide (Al₂O₃), or other materials. In one embodiment, first elution preventive layer 140 is formed by a chemical vapor deposition (CVD) process.

Second plate 120 includes chamber portions 122, partition portions 124, and sealing portions 126. Chamber portions 122 are separated apart from first plate 110 to form discharge chambers 130. Partition portions 124 contact first plate 110 to separate discharge chambers 130. Sealing portions 126 are disposed at edges of second plate 120 and contact first plate 110.

As shown in the cross-sectional view of flat fluorescent lamp 100 in FIG. 2, each of discharge chambers 130 are substantially arch-shaped, are connected to neighboring discharge chambers 130, and are separated by a substantially uniform distance therebetween. In other embodiments, discharge chambers 130 can exhibit substantially semi-circular, quadrangular, or trapezoidal shapes, or other shapes.

Second plate 120 can include one or more connection paths 128 between adjacent discharge chambers 130. Connection paths 128 can be used to exhaust air from discharge chambers 130, provide pathways where air or discharge gas can move between discharge chambers 130, and uniformly distribute discharge gas in discharge chambers 130. Connection paths 128 can be formed at the same time that second plate 120 is processed to have a desired shape. Connection paths 128 can have various shapes. For example, in one embodiment, connection paths 128 can be bent to have an “S” shape which can increase the path length between adjacent discharge chambers 130 to facilitate uniform discharge current flow and reduced channeling in discharge chambers 130.

First plate 110 and second plate 120 are coupled with an adhesive member 150, such as frit (i.e. a mixture of glass and metal) having a lower melting point than glass. Adhesive member 150 is interposed between first plate 110 and sealing portion 126 of second plate 120, heated and melted, and then solidified to combine first plate 110 and second plate 120. In one embodiment, adhesive member 150 can be heated to a temperature in a range of about 400° C. to about 600° C.

After first and second plates 110 and 120 are combined, air in discharge chambers 130 is exhausted to form a vacuum. Discharge gases, such as mercury, neon (Ne), argon (Ar), or other gasses are then injected into discharge chambers 130.

A pressure difference between inner and outer spaces of flat fluorescent lamp 100 causes partition portions 124 to adhere closely to first plate 110. For example, in one embodiment, the pressure of discharge gases in discharge chambers 130 is in a range of about 50 torr to about 70 torr, and atmospheric pressure external to flat fluorescent lamp 100 is about 760 torr. The external force on flat fluorescent lamp 100 caused by this pressure difference forces partition portions 124 against first plate 110.

Flat fluorescent lamp 100 includes a first fluorescent layer 160 and a second fluorescent layer 165 above first plate 110 and second plate 120, respectively. In FIGS. 1 to 3, second fluorescent layer 165 is formed on first elution preventive layer 140. That is, first elution preventive layer 140 is disposed between second plate 120 and second fluorescent layer 165. First and second fluorescent layers 160 and 165 can be excited by ultraviolet rays generated by plasma discharge inside discharge chambers 130, thereby causing first and second flat fluorescent layers 160 and 165 to emit visible light.

Flat fluorescent lamp 100 includes a reflective layer 170 between first plate 110 and first fluorescent layer 160. Reflective layer 170 can reflect visible light emitted by first and second fluorescent layers 160 and 165 toward second plate 120, thereby reducing light leakage through first plate 110. In one embodiment, reflective layer 170 is about 80 μm thick, first fluorescent layer 160 is about 40 μm thick, and second fluorescent layer 165 is about 15 μm thick. First elution preventive layer 140 is formed on second plate 120 to prevent sodium from eluting from second plate 120. Reflective layer 170 and first fluorescent layer 160 are relatively thick (e.g., second fluorescent layer can have a smaller thickness than first fluorescent layer 165) to prevent sodium from eluting from first plate 110.

Flat fluorescent lamp 100 includes external electrodes 180 formed on at least one outer surface of first plate 110 and second plate 120. For example, external electrodes 180 can be formed across and at opposite ends of discharge chambers 130 and used to apply an electric field to discharge chambers 130. External electrodes 180 formed on first plate 110 and second plate 120 can be connected by conductive clips (not shown).

External electrodes 180 can be formed of conductive material, such as a silver paste including silver (Ag) and silicon oxide, a metal, a metal alloy, or other conductive material. In one embodiment, external electrodes 180 can be deposited by a spray, a spin coating, a dipping, or other deposition techniques. In another embodiment, external electrodes 180 are provided by a metal socket.

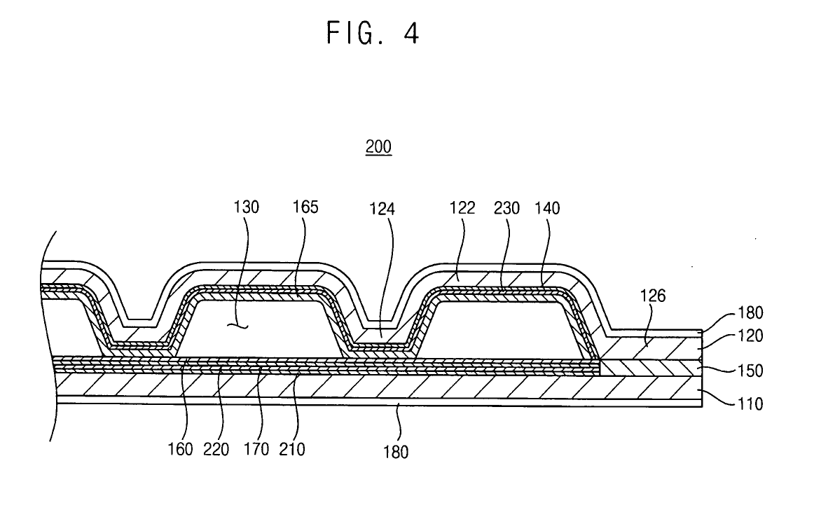

FIG. 4 is a cross-sectional view of another embodiment of a flat fluorescent lamp 200 which is substantially identical to flat fluorescent lamp 100 of FIG. 2, except for the addition of first and second protective layers, and a second elution preventive layer. Accordingly, further explanation of previously described aspects of FIG. 4 will be omitted in the following discussion.

Flat fluorescent lamp 200 includes first plate 1 10 and second plate 120 which are coupled to provide discharge chambers 130. First fluorescent layer 160 is formed above first plate 110. Second fluorescent layer 165 is formed above second plate 120. Reflective layer 170 is disposed between first plate 110 and first fluorescent layer 160. First elution preventive layer 140 is disposed between second plate 120 and second fluorescent layer 165.

Flat fluorescent lamp 200 includes a second elution preventive layer 210 between first plate 110 and reflective layer 170. Second elution preventive layer 210 reduces sodium elution from first plate 110. In one embodiment, second elution preventive layer 210 is formed of silicon oxide, silicon nitride, aluminum oxide, or other material. In another embodiment, second preventive layer 210 is formed by a CVD process and is about 300 Å thick.

Flat fluorescent lamp 200 includes first protective layer 220 between reflective layer 170 and first fluorescent layer 160. First protective layer 220 prevents mercury in discharge chambers 130 from entering and reacting with first plate 110, thereby reducing mercury loss from discharge chambers 130 and further reducing the formation of dark spots on first plate 110. In one embodiment, first protective layer 220 is formed of yttrium oxide (Y₂O₃) and is about 2 μm thick.

Flat fluorescent lamp 200 includes a second protective layer 230 between first elution preventive layer 140 and second fluorescent layer 165. Second protective layer 230 prevents mercury in discharge chambers 130 from entering and reacting with second plate 120, thereby reducing mercury loss from discharge chambers 130 and further reducing the formation of dark spots on second plate 120. In one embodiment, second protective layer 230 is formed of yttrium oxide and is about 1 μm thick.

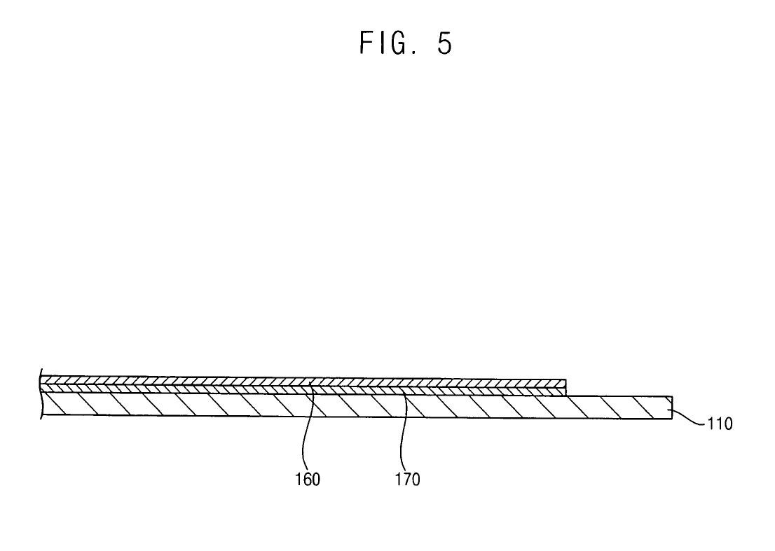

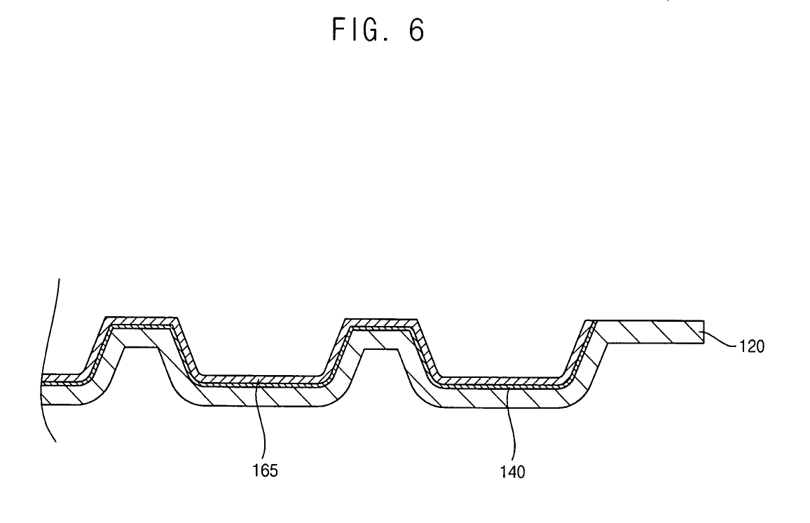

Hereinafter, a method for manufacturing a flat fluorescent lamp in accordance with an embodiment of the present invention will be described in detail with reference to FIGS.5 and 6. Referring to FIG. 5, reflective layer 170 and first fluorescent layer 160 are sequentially formed. In one embodiment, reflective layer 170 is about 80 μm thick and first fluorescent layer 160 is about 40 μm thick.

Referring to FIG. 6, second plate 120 is processed to have a desired shape by heating second plate 120 to a temperature (e.g., about 750° C.) equal or greater than the softening point of the sodalime glass, and then compressing second plate 120 with air using blow molding techniques. In another embodiment, second plate 120 is processed to have a desired shape by heating and pressing sodalime glass with a cast.

First elution preventive layer 140 is then formed on second plate 120 through, for example, a CVD process. In one embodiment, first elution preventive layer 140 is about 300 Å thick and can be formed of silicon oxide, silicon nitride, aluminum oxide, or other material.

Table 1 shows the amount of sodium eluted from three embodiments of second plate 120 at a temperature of about 700° C. In example 1, second plate 120 is provided without first elution preventive layer 140. In examples 2 and 3, first elution preventive layer 140 is provided on second plate 120 but is formed in different ways. Specifically, in Example 2, first elution preventive layer 140 is formed on second plate 120 before second plate 120 is formed into its desired shape. In example 3, first elution preventive layer 140 is formed on second plate 120 after second plate 120 is formed into its desired shape.

TABLE 1

| | Example 1 | Example 2 | Example 3 |
|---|---|---|---|
| Sodium (wt %) | 21.0 | 18.1 | 0 |

Referring to Table 1, although examples 2 and 3 both include first elution preventive layer 140, approximately 18 wt % sodium is detected for example 2, whereas, approximately 0 wt % sodium is detected in example 3. Accordingly, it will be appreciated that first elution preventive layer 140 can reduce sodium elution from second plate 120. In particular, where first elution preventive layer 140 is formed after second plate 120 is formed into its desired shape, the amount of eluted sodium can be prevented from rising above approximately 10 wt %, thereby increasing the lifetime of flat fluorescent lamp 100.

In another embodiment as shown in FIG. 4, a second elution preventive layer 210 can be formed between first plate 110 and reflective layer 170. Second elution preventive layer 210 reduces the elution of sodium from first plate 110. In one embodiment, second elution preventive layer 210 is about 300 Å and is formed by a CVD process. Second elution preventive layer 210 can be formed of silicon oxide, silicon nitride, aluminum oxide, or other material.

A first protective layer 220 can be formed on reflective layer 170 before first fluorescent layer 160 is formed. First protective layer 220 prevents mercury in discharge chambers 130 from entering and reacting with first plate 110, thereby reducing mercury loss and formation of black spots on first plate 110. In one embodiment, first protective layer is formed of yttrium oxide and is about 2 μm thick.

A second protective layer 230 can be formed on first elution preventive layer 140 before second fluorescent layer 165 is formed. Second protective layer 230 prevents mercury in discharge chambers 130 from entering and reacting with second plate 120, thereby reducing mercury loss and formation of black spots on second plate 120. In one embodiment, second protective layer is formed of yttrium oxide and is about 1 μm thick.

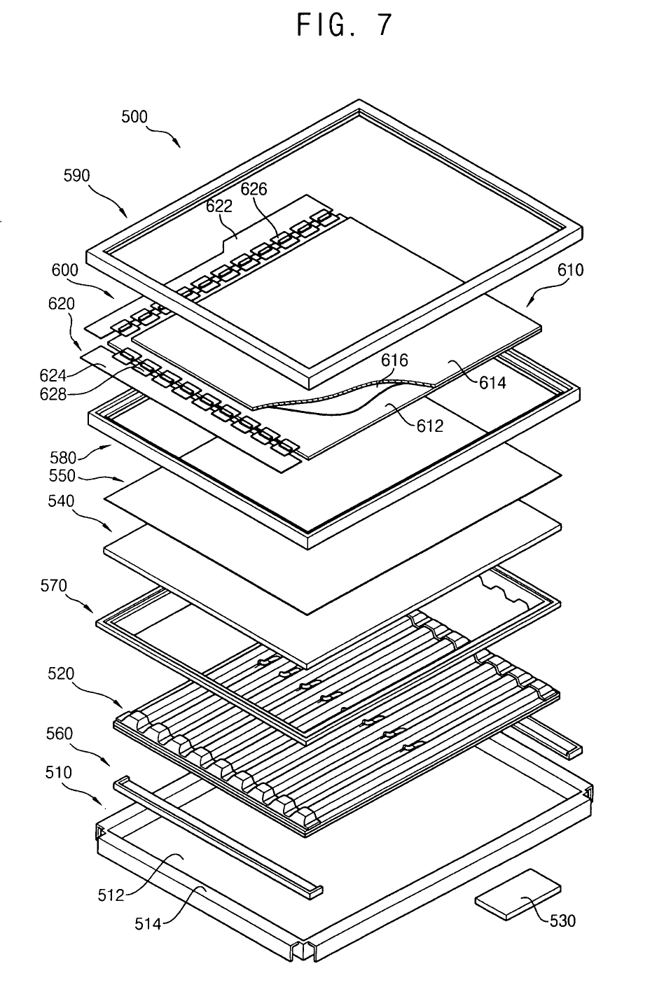

FIG. 7 is an exploded perspective view of an LCD 500 in accordance with an embodiment of the present invention. LCD 500 includes a receiving container 510, a flat fluorescent lamp 520, and a display unit 600. Receiving container 510 includes a bottom plate 512 and sidewalls 514 extending from bottom plate 512. Sidewalls 514 have a double-bent structure to form an inverted U-shape to securely combine sidewalls 514 with other components such as a top chassis. In one embodiment, receiving container 510 is formed of a durable metal which is resistant to deformation.

Flat fluorescent lamp 520 is disposed on receiving container 510 and emits light in response to a discharge voltage provided by an inverter 530. Flat fluorescent lamp 520 can be implemented by flat fluorescent lamp 100 or 200 illustrated in FIGS. 1 to 4. Accordingly, further explanation of previously described aspects of FIGS. 1 to 4 will be omitted in the following discussion.

Display unit 600 includes a LCD panel 610 to display images using light provided by flat fluorescent lamp 520. Display unit 600 also includes driving circuit 620 to drive LCD panel 610. LCD panel 610 includes a first substrate 612, a second substrate 614 facing first substrate 612, and a liquid crystal 616 disposed therebetween. First substrate 612 includes thin film transistors (TFTs) arranged in a matrix type. Each TFT has a source electrode connected to a data line, a gate electrode connected to a gate line, and a drain electrode connected to a pixel electrode formed of transparent conductive material. Second substrate 615 includes color filters to represent primary colors red, green, and blue, and a common electrode formed of transparent conductive material. LCD panel 610 displays images by applying voltages to the pixel electrodes and the common electrodes to generate electric fields in the LC layer, which control the orientation of the LC molecules in the LC layer to affect the polarization of light provided from flat fluorescent lamp 520 passing through the LC layer.

Driving circuit 620 includes a data printed circuit board (PCB) 622 to provide data signals to LCD panel 610, a gate PCB 624 to provide gate signals to LCD panel 610, data flexible printed circuit (FPC) films 626 to connect data PCB 622 to LCD panel 610, and gate FPC films 628 to connect gate PCB 624 to LCD panel 610. Data FPC film 626 and gate FPC film can each be implemented as a tape carrier package (TCP) or a chip on film (COF). Alternatively, gate PCB 624 can be replaced by signal lines formed on LCD panel 610 and gate FPC films.

LCD 500 includes an inverter 530 to provide a discharge voltage. Inverter 530 is disposed at a backside of receiving container 510. Inverter 530 converts a low voltage of alternating current to a high voltage of alternating current which is provided to external electrodes 180 of flat fluorescent lamp 520 through lamp wires (not shown).

LCD 500 includes a diffusing plate 540 disposed on flat fluorescent lamp 520 and at least one optical sheet 550 on diffusing plate 540. Diffusing plate 540 uniformly distributes light emitted from flat fluorescent lamp 520 and is disposed apart from flat fluorescent lamp 520. Diffusing plate 540 can be formed of a transparent material that includes diffusing agents. In one embodiment, diffusing plate 540 is formed of polymethyl methacrylate (PMMA).

Optical sheet 550 guides light diffused by diffusing plate 540 to increase luminance of LCD 500. For example, optical sheet 550 can include a prism sheet to guide the diffused light toward a front of LCD 500. Also, optical sheet 550 can include a diffusing film to further diffuse the light, and a reflective polarizing film to transmit portions of the light and reflect other portions. In various embodiments, one or more optical sheets 550 can be provided.

LCD 500 includes buffering members 560 between flat fluorescent lamp 520 and receiving container 510 to support edges of flat fluorescent lamp 520. Buffering members 560 are disposed at edges of flat fluorescent lamp 520 to separate and electrically insulate flat fluorescent lamp 520 from receiving container 510 which can be formed of metal. Buffering members 560 can be formed of elastic and insulating material such as silicon to protect flat fluorescent lamp 100 from impacts.

LCD 500 includes a first mold 570 between flat fluorescent lamp 520 and diffusing plate 540. First mold 570 fixes the edges of flat fluorescent lamp 520 with respect to receiving container 510 and supports the edges of diffusing plate 540. First mold 570 also blocks external electrodes 180 of flat fluorescent lamp 520 to decrease shadows. First mold 570 can be implemented as one frame, two pieces (e.g., two U-shaped or L-shaped pieces), or four pieces (e.g., corresponding to its four sides).

LCD 500 includes a second mold 580 disposed over first mold 570 to fix diffusing plate 540 and optical sheet 550 with respect to first mold 570. Second mold 580 can be implemented as one frame, two pieces, or four pieces.

LCD 500 includes a top chassis 590 which can be joined with receiving container 510 and can fix display unit 600 with second mold 580. In one embodiment, top chassis 590 is formed of a durable metal. Data PCB 622 can be backwardly bent and disposed on a sidewall or a bottom side of receiving container 510.

In accordance with the embodiments of the present invention described and illustrated herein, a flat fluorescent lamp can include an elution preventive layer to reduce sodium elution from first or second plates formed of sodalime glass. As a result, the lifetime and light characteristics of the flat fluorescent lamp can be enhanced. By forming the elution preventive layer after the second plate is processed to have a desired shape, sodium elution can be more efficiently prevented.

As those of skill in this art will appreciate, many modifications, substitutions, and variations can be made in the materials, apparatus, configurations, and methods of the present invention without departing from its spirit and scope. In light of this, the scope of the present invention should not be limited to that of the particular embodiments illustrated and described herein, as they are only exemplary in nature, but instead, should be fully commensurate with that of the claims appended hereafter and their functional equivalents.

What is claimed is:

1. A flat fluorescent lamp comprising:
a first plate;
a second plate adapted to form a plurality of discharge chambers in combination with the first plate;
a first elution preventive layer on an inner surface of the second plate;
a first fluorescent layer above an inner surface of the first plate; and
a second fluorescent layer above the first elution preventive layer.

2. The flat fluorescent lamp of claim 1, wherein the first elution preventive layer comprises at least one selected from the group consisting of: silicon oxide, silicon nitride, and aluminum oxide.

3. The flat fluorescent lamp of claim 1, wherein the first and second plates comprise sodalime glass.

4. The flat fluorescent lamp of claim 1, wherein the second plate comprises:
chamber portions separated apart from the first plate to form the discharge chambers;
partition portions adapted to separate the discharge chambers; and
sealing portions at edges of the second plate.

5. The flat fluorescent lamp of claim 1, further comprising a reflective layer between the first plate and the first fluorescent layer.

6. The flat fluorescent lamp of claim 5, further comprising a second elution preventive layer between the first plate and the reflective layer.

7. The flat fluorescent lamp of claim 5, further comprising:
a first protective layer between the reflective layer and the first fluorescent layer; and
a second protective layer between the first elution preventive layer and the second fluorescent layer.

8. A flat fluorescent lamp comprising:
a first plate;
a second plate adapted to form a plurality of discharge chambers in combination with the first plate; and
a first elution preventive layer on an inner surface of the second plate and adapted to prevent sodium eluted from the second plate from exceeding a predetermined sodium elution amount.

9. The flat fluorescent lamp of claim 8, wherein the sodium elution amount is in a range of about 0 wt % to about 10 wt %.

10. The flat fluorescent lamp of claim 8, wherein the first elution preventive layer comprises at least one selected from the group consisting of: silicon oxide, silicon nitride, and aluminum oxide.

11. The flat fluorescent lamp of claim 8, further comprising:
a first fluorescent layer above an inner surface of the first plate; and
a second fluorescent layer above the first elution preventive layer.

12. A liquid crystal display (LCD) device comprising:
a LCD panel adapted to display images;
a driving circuit adapted to provide a plurality of data signals and gate signals to the LCD panel;
a flat fluorescent lamp configured to provide light to the LCD panel, wherein the flat fluorescent lamp comprises:
a first plate,
a second plate adapted to form a plurality of discharge chambers in combination with the first plate,
a first elution preventive layer on an inner surface of the second plate and adapted to prevent sodium eluted from the second plate from exceeding a predetermined sodium elution amount,
a first fluorescent layer above an inner surface of the first plate, and
a second fluorescent layer above the first elution preventive layer; and
an inverter adapted to provide a discharge voltage to the flat fluorescent lamp.

13. A method for manufacturing a flat fluorescent lamp, the method comprising:
forming a first fluorescent layer above an inner surface of a first plate;
molding a second plate to have a desired shape;
forming a first elution preventive layer on an inner surface of the second plate;
forming a second fluorescent layer above the first elution preventive layer; and
combining the first and second plates to form a plurality of discharge chambers, wherein the inner surfaces of the first and second plates face each other.

14. The method of claim 13, wherein the first elution preventive layer comprises at least one selected from the group consisting of: silicon oxide, silicon nitride, and aluminum oxide.

15. The method of claim 13, wherein the first and second plates comprise sodalime glass.

16. The method of claim 13, wherein the first elution preventive layer is formed by a chemical vapor deposition (CVD) process.

17. The method of claim 13, further comprising forming a reflective layer between the first plate and the first fluorescent layer.

18. The method of claim 17, further comprising forming a second elution preventive layer between the first plate and the reflective layer.

19. The method of claim 17, further comprising:
forming a first protective layer between the reflective layer and the first fluorescent layer; and
forming a second protective layer between the first elution preventive layer and the second fluorescent layer.

20. The method of claim 13, further comprising preventing sodium eluted from the second plate from exceeding a predetermined sodium elution amount.
